(19) United States
(12) Patent Application Publication
(10) Pub. No.: US 2020/0143394 A1
(43) Pub. Date: May 7, 2020

(54) EVENT IMPACT ANALYSIS

(71) Applicant: SAP SE, Walldorf (DE)

(72) Inventor: Cheng Yu Yao, Richmond (CA)

(21) Appl. No.: 16/177,871

(22) Filed: Nov. 1, 2018

(51) Int. Cl. G06Q 30/02; G06F 17/50; G06Q 10/06

(52) U.S. Cl. CPC G06Q 30/0202; G06N 7/005; G06Q 10/067; G06F 17/5009

(57) ABSTRACT

A system includes determination of a measure, a set of dimension members and an event associated with a data source, determination of control dimension members associated with the event, determination of first values of the measure aggregated over a control period and over the set of dimension members, determination of second values of the measure aggregated over the control period and control dimension members, and not aggregated over at least one of the set of dimension members, determination a model associating the first values and the second values, determination of predicted values of the measure over a prediction period occurring after the control period, based on the model and on values of the measure aggregated over the prediction period and over the control dimension members, and not aggregated over at least one of the set of dimension members, and generation a visualization based on the predicted values of the measure and values of the measure aggregated over the prediction period and over the set of dimension members.

### BACKGROUND

Enterprise software systems receive, generate, and store data related to many aspects of an enterprise. Users operate reporting tools to access such data and display the data in useful formats, such as in graphic visualizations. Specifically, a reporting tool may submit a query to a backend data source and present a visualization of a corresponding result set.

Some reporting tools also provide predictive analysis of stored data. Predictive analysis may predict future values of a measure (e.g., Sales) based on prior values of the measure. While predictive analysis may provide some information which is usable to guide future decisions and resource planning, predictive analysis fails to provide satisfactory insight into the reasons and/or causes underlying stored historical data. Systems are desired to efficiently estimate and present the impact of past events on stored data.

### BRIEF DESCRIPTION OF THE DRAWINGS

FIG. 1 is a view of a data visualization and user interface according to some embodiments.

FIG. 2 is a block diagram of a system architecture according to some embodiments.

FIG. 3 is a flow diagram of a process according to some embodiments.

FIG. 4 is a view of a user interface to define event metadata according to some embodiments.

FIG. 5 is a view of a user interface to define event metadata according to some embodiments.

FIG. 6 illustrates generation of a model based on event metadata according to some embodiments.

FIG. 7 illustrates generation of predicted values based on a generated model according to some embodiments.

FIG. 8 is a flow diagram of a process according to some embodiments.

FIG. 9 is a view of a data visualization and user interface depicting causal analysis according to some embodiments.

FIG. 10 is a view of a data visualization and user interface depicting causal analysis according to some embodiments.

FIG. 11 is a block diagram of an apparatus according to some embodiments.

### DETAILED DESCRIPTION

The following description is provided to enable any person in the art to make and use the described embodiments. Various modifications, however, will remain readily apparent to those in the art.

Generally, some embodiments determine the impact of past events on subsequent data measures. For example, some embodiments may estimate a change to total Income which is attributable to an event such as a marketing campaign, a corporate acquisition, a natural disaster, or a news event. In some embodiments the impact is determined by estimating the value of the measure in the absence of the event.

Embodiments facilitate the definition of events for use in the above-described determination. An event definition may include a list of related tags such as an event description, a start and end date, an event type. An event definition also includes control members. As will be described below, the defined control members assist in the estimation of the value of the measure in the absence of the event. Events may be defined by a system operator, for example in the case of an enterprise-related event such as a marketing campaign or a corporate acquisition, or by an automated process receiving event metadata from the enterprise and/or from external sources (e.g., in the case of external events).

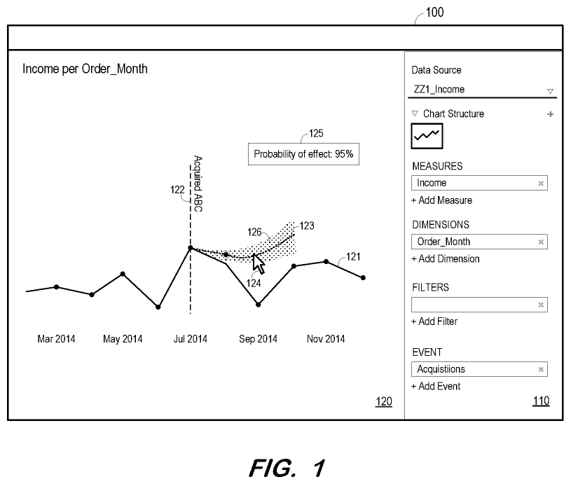

FIG. 1 illustrates interface 100 according to some embodiments. Embodiments are not limited to interface 100.

As a brief introduction, visualization area 120 displays line 121 which depicts Income values for each of several months of year 2014. Area 120 also displays dashed line 122, indicating an occurrence of an event entitled “Acquired ABC”. As described above, some embodiments estimate hypothetical values of a measure in the absence of a prior event. In the present example, dashed line 123 illustrates those estimated values, which were determined under the assumption that the “Acquired ABC” event did not occur. The determination of estimated values according to some embodiments is described in detail below. Shaded area 126 indicates an error range associated with the determination of the estimated values, and graphic 125 indicates a calculated probability that the event impacted the subject measure.

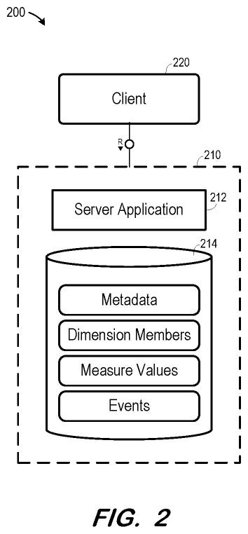

The functionality and operation of user interface 100 according to some embodiments will be described in detail below. To assist in the understanding of the description, FIG. 2 is a block diagram of system architecture 200 according to some embodiments. Embodiments are not limited to system architecture 200 or to a database architecture.

Architecture 200 includes data server 210 and client 220. Generally, data server 210 receives requests from client 220 and provides results to client 220 based on those requests. Server application 212 may be separated from or closely integrated with data store 214. Server application 212 may be executed completely on the database platform of data store 214, without the need for an additional server. Architecture 200 may be implemented using any client-server architecture that is or becomes known, including but not limited to on-premise, cloud-based and hybrid architectures.

In one specific example, client 220 executes an application to present a user interface to a user. The user enters a query into the user interface, and client 220 forwards a request based on the query to server 210. Server application 212 generates an SQL script based on the request and forwards the SQL script to data store 214. Data store 214 executes the SQL script to return a result set based on data of data store 214, and client 220 generates and displays a report/visualization based on the result set.

Data store 214 stores metadata, dimension members, measure values and events. Generally, the metadata defines data objects such as dimensions, measures and events, and the dimension members, measure values and events include data representing actual (i.e., instantiated) versions of those objects. Dimensions are logical entities along which an analysis or report may be executed (e.g., Year, Country, Product), and measures (e.g., Sales, Profit) are values which can be determined for a given combination of dimension values, or dimension members (e.g., Sales for 2006, U.S.A., Televisions). The metadata of data store 214 associates each measure, dimension and event with one or more physical entities (e.g., a physical database table, associated columns of one or more database tables, etc.).

The data of data store 214 may comprise one or more of conventional tabular data, row-based data, column-based data, and object-based data. Moreover, the data may be indexed and/or selectively replicated in an index to allow fast searching and retrieval thereof. Data store 214 may support multi-tenancy to separately support multiple unrelated clients by providing multiple logical database systems which are programmatically isolated from one another.

Data store 214 may comprise any query-responsive data source or sources that are or become known, including but not limited to a structured-query language (SQL) relational database management system. Data store 214 may comprise a relational database, a multi-dimensional database, an eXtendable Markup Language (XML) document, or any other data storage system storing structured and/or unstructured data. The data of data store 214 may be distributed among several relational databases, dimensional databases, and/or other data sources. Embodiments are not limited to any number or types of data sources.

Data store 214 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Client 220 may comprise one or more devices executing program code of an application for presenting user interfaces to allow interaction with server 210. The user interfaces may be suited for reporting, data analysis, and/or any other functions based on the data of data store 214.

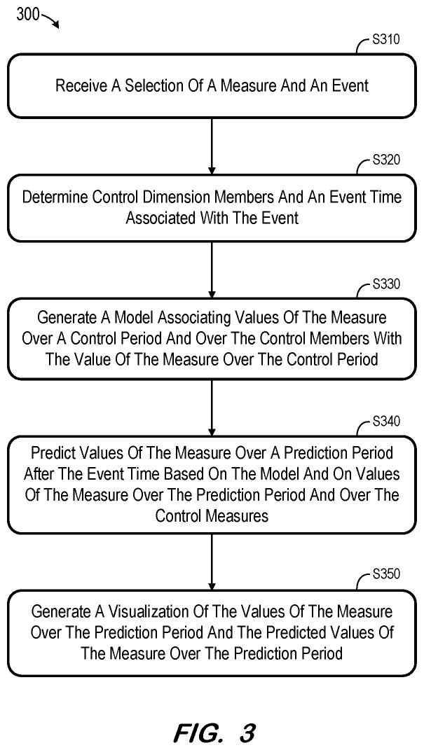

FIG. 3 comprises a flow diagram of process 300 according to some embodiments. Process 300 may be executed to estimate an impact on prior measure values caused by the occurrence of an event.

In some embodiments, various hardware elements of system 200 execute program code to perform process 300. Process 300 and all other processes mentioned herein may be embodied in computer-executable program code read from one or more of non-transitory computer-readable media, such as a non-volatile random access memory, a hard disk, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a measure and an event are selected at S310. The following example of S310 will be described with respect to FIG. 1, but S310 may include any suitable system for selecting an event and a measure.

Interface 100 of FIG. 1 may comprise a Web page displayed by a Web browser application executing on a client device. The Web page may be provided by a cloud-based or on-premise Web server. Interface 100 is not limited to Web-based formats. User interface and data visualizations described herein may be rendered on server 210 or may be transmitted to client 220 as XML, HTML and JavaScript for rendering thereon as described above.

Interface 100 includes query definition area 110 to receive elements of a query from a user. Area 110 includes fields which allow a user to specify a data source to which the query will be applied, a chart structure (e.g., pie, line, bar, etc.), one or more measures, one or more dimensions, and one or more filters. As shown in FIG. 1, the fields have been manipulated to specify a line chart, the measure Income, and the Dimension Member Order_Month.

Area 110 also includes an input control for selection of one or more Events. In the illustrated embodiment, the Event input control allows selection of Event types, and the selected Event type is “Acquisitions”. Such a selection constitutes a selection of all Events of type Acquisition. Some embodiments may allow for selection of individual events, and for filtering of the selection by date, type and other criteria.

Next, at S320, control dimension members and an event time associated with the event are determined. In this regard, each Event is associated with control dimension members and an event time according to some embodiments. The control dimension members and the event time may be defined by a user, administrator, or automatically generated.

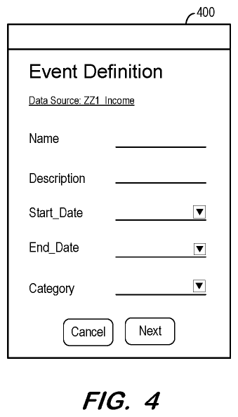

FIG. 4 is a view of user interface 400 for receiving Event metadata according to some embodiments. Server application 212 may provide interface 400 to client 220 in response to a command to create or edit an Event within a data source. Interface 400 provides a metaphor to input a Name, Description, Start Date, End Date and Event Category. These metadata may be stored within data store 214 for use during operation as described herein.

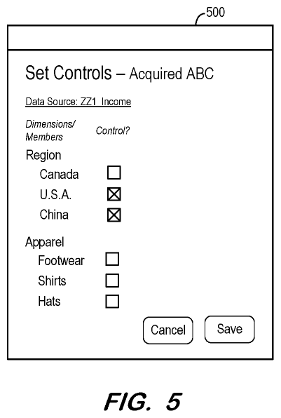

FIG. 5 depicts interface 500 according to some embodiments. Interface 500 allows a user or operator to define control dimension members for an Event. Control dimension members are defined such that the value of a measure calculated across the control dimension members will be similar regardless of whether the associated Event did or did not occur.

For example, if the Event is a marketing event related to a particular product type (e.g., Footwear) in a particular region (e.g., Canada), it might be assumed that the sales in other regions might not be affected. Accordingly, the U.S.A. and China might be selected as control dimension members. Considered differently, it might be assumed that sales of other product types might not be affected by the Event and the product types Shirts and Hats may therefore be selected as the control dimension members.

A model is generated at S330. The model associates values of the measure over the control dimension members with the value of the selected measure, over a control period. In other words, the model is a function relating values of the selected measure filtered by the control dimension members (in addition to whatever other filters are currently selected) to contemporaneous values of the selected measure filtered only by the currently-selected filters.

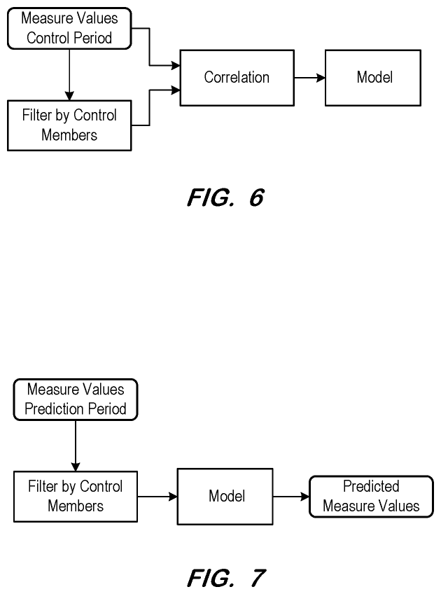

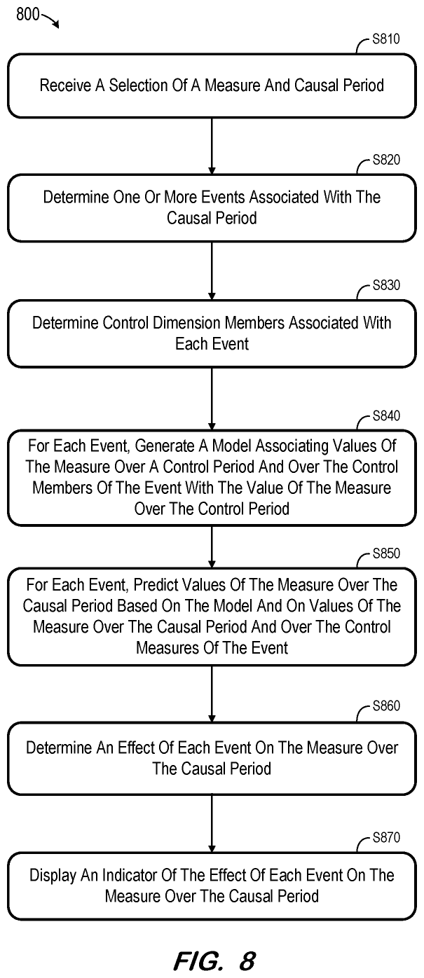

FIG. 6 illustrates generation of a model at S330 according to some embodiments. The model is generated by correlating values of the selected measure over a control period with values of the selected measure over the control period and filtered by the control dimension members. Referring to the example of FIGS. 1, 4 and 5, values of the Income measure are determined for each of several months prior to the July 2014 start date of the Acquired ABC Event (i.e., the control period). The determined values are aggregated over all regions and product types as indicated by interface 100.

Next, values of the Income measure are determined for the same months, but aggregated over all product types and only the regions U.S.A. and China. Accordingly, the selected control dimension members of FIG. 5 reflect an assumption that the Acquired ABC Event will have minimal or insignificant (for purposes of this analysis) effect on the Income aggregated over all product types and the regions U.S.A. and China.

The model may be generated based on the two sets of measure values using any system that is or becomes known. According to some embodiments, the model is a Bayesian network which is trained based on the two sets of measure values. The model may comprise an artificial neural network which is trained at S330 based on the two sets of measure values.

The model is used to generate predicted values of the selected measure at S340. FIG. 11 depicts the generation of predicted values according to some embodiments. First, values of the measure are determined based on the control dimension members and for a prediction period following the start date of the selected Event. In the present example, the prediction period is July 2014 through October 2014. The measure Income is determined for each month of this period, aggregated over all product types and only the regions U.S.A. and China. The determined values are then input into the generated model to generate a predicted value of the Income measure over all regions for each month of the prediction period.

A visualization is generated at S350. The visualization may include the actual values of the measure over the prediction period as well as the values predicted at S340. According to one non-exhaustive example, FIG. 1 shows dashed line 123 of predicted values, which provides a visual contrast to the corresponding portion of line 121 representing the actual values. As mentioned above, shaded area 126 reflects an error range provided by the model. Interface 100 also includes graphic 125 which provides a calculated probability that the event affected the actual measure values. This probability may be calculated based on a comparison of the predicted and actual values over the prediction period, using any system that is or becomes known. In the case of a Bayesian model, the probability is the “p” value.

Some embodiments may thereby efficiently provide a determination and an intuitive view of the impact on a measure caused by an event. Relatedly, process 800 is a flow diagram of a process to identify causes behind the values of a measure over time.

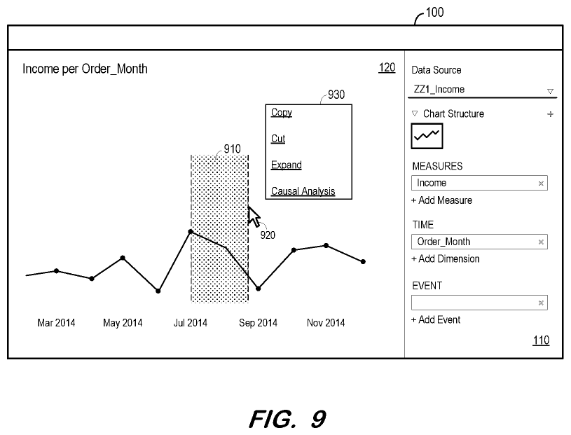

Initially, a measure and a causal period are selected and the selection is received at S810. FIG. 9 illustrates selection of causal period 910 using cursor 920 and a click-and-drag metaphor, but embodiments are not limited thereto. The user has right-clicked to invoke context menu 930 presenting a “Causal Analysis” menu item. Selection of this menu item causes flow to proceed to S820.

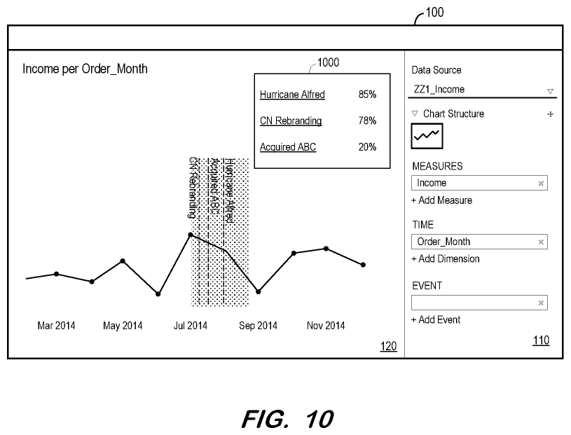

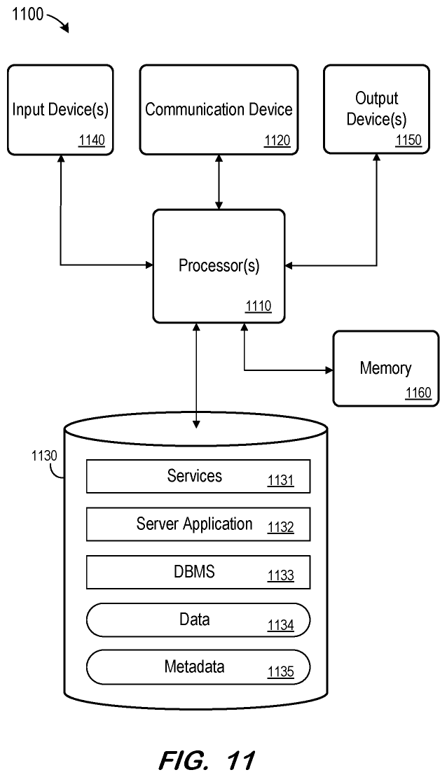

At S820, one or more events associated with the causal period are determined. The determined events may be those predefined events which are associated with a start date during the causal period. FIG. 10 illustrates interface 100 showing each event determined for the causal period at S820.

Control dimension members associated with each event are determined at S830 as described above. The control dimension members for each event may differ from one another. Next, at S840, a model is generated for each determined event based on actual and control dimension-filtered values over a control period as described with respect to S330. Similarly to S340, and for each determined event, predicted measure values for the causal period are determined at S850 based on the model generated for the event.

At S860, an effect of each event is determined based on a comparison between the actual measure values over the causal period and the predicted measure values associated with the event. An indicator may then be displayed at S870, representing the effect of each event on the measure over the causal period. FIG. 10 shows graphic 1000 associating each Event with an effect expressed as a probability.

As described above, events may be internal to an organization and specified by an operator familiar with events within the organization. In some embodiments, the events may include “external” events determined from external sources. These external events may be used to perform impact and causal analysis as described above, in conjunction with or separate from the “internal” events.

For example, a system may monitor news aggregation services to identify events and associated metadata tags assigned by the services. The system may create Events in data store 214 for identified events which are associated with certain topics, or for identified events having a particular level of Web presence (e.g., determined based on tweet hashtags). The start date and end date of such events may be based on the number and velocity of appearances on the Web. The control dimension members for an identified event may be determined based on region metadata tags or topic metadata tags as described above.

FIG. 11 is a block diagram of apparatus 1100 according to some embodiments. Apparatus 1100 may comprise a general-purpose computing apparatus and may execute program code to perform any of the functions described herein. Apparatus 1100 may comprise an implementation of server 210 of FIG. 1 in some embodiments. Apparatus 1100 may include other unshown elements according to some embodiments.

Apparatus 1100 includes processor(s) 1110 operatively coupled to communication device 1120, data storage device 1130, one or more input devices 1140, one or more output devices 1150 and memory 1160. Communication device 1120 may facilitate communication with external devices, such as a reporting client, or a data storage device. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen), a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM), Storage Class Memory (SCM) or any other fast-access memory.

Services 1131, server application 1132 and DBMS 1133 may comprise program code executed by processor 1110 to cause apparatus 1100 to perform any one or more of the processes described herein. Embodiments are not limited to execution of these processes by a single apparatus.

Data 1134 and metadata 1135 (either cached or a full database) may be stored in volatile memory such as memory 1160. Metadata 1135 may include information regarding dimensions, dimension values, measures and events associated with the data sources stored within data 1134. Data storage device 1130 may also store data and other program code for providing additional functionality and/or which are necessary for operation of apparatus 1100, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a user device to:
receive, from a user, a selection of a measure and an event associated with a data source; and
a server device to:
determine control dimension members of a dimension associated with the event;
determine an association between values of the measure aggregated over a control period and over the control dimension members and at least one other dimension member of the dimension, and values of the measure aggregated over the control period and over the control dimension members;
determine predicted values of the measure aggregated over a prediction period occurring after the control period, based on the determined association and on values of the measure aggregated over the prediction period and over the control dimension members; and
generate a visualization based on a comparison between the predicted values of the measure and values of the measure aggregated over the prediction period and over the control dimension members and at least one other dimension member of the dimension,
wherein the user device is to display the visualization.

2. A system according to claim 1, wherein the visualization depicts the predicted values of the measure and values of the measure aggregated over the prediction period and over the control dimension members and at least one other dimension member of the dimension.

3. A system according to claim 2, wherein the visualization indicates a probability that the event impacted the values of the measure aggregated over the prediction period and over the control dimension members and at least one other dimension member of the dimension.

4. A system according to claim 1, wherein selection of the event comprises selection of a time period, and wherein the server device is to:
determine the event and a second event based on the time period, a time associated with the event, and a time associated with the second event;
determine second control dimension members of the dimension associated with the event;
determine a second association between the values of the measure aggregated over a control period and over the control dimension members and at least one other dimension member of the dimension, and second values of the measure aggregated over the control period and over the second control dimension members; and
determine second predicted values of the measure aggregated over a prediction period occurring after the control period, based on the determined second association and on second values of the measure aggregated over the prediction period and over the second control dimension members,
wherein the visualization is based on a comparison between the second predicted values of the measure and second values of the measure aggregated over the prediction period and over the control dimension members and at least one other dimension member of the dimension.

5. A system according to claim 1, wherein determination of the association comprises training a Bayesian network.

6. A computer-implemented method comprising:
determining a measure, a set of dimension members and an event associated with a data source;
determining control dimension members associated with the event;
determining first values of the measure aggregated over a control period and over the set of dimension members;
determining second values of the measure aggregated over the control period and control dimension members, and not aggregated over at least one of the set of dimension members;
determining a model associating the first values and the second values;
determining predicted values of the measure over a prediction period occurring after the control period, based on the model and on values of the measure aggregated over the prediction period and over the control dimension members, and not aggregated over at least one of the set of dimension members; and
generating a visualization based on the predicted values of the measure and values of the measure aggregated over the prediction period and over the set of dimension members.

7. A method according to claim 6, wherein the visualization depicts the predicted values of the measure and values of the measure aggregated over the prediction period and over the set of dimension members.

8. A method according to claim 7, wherein the visualization indicates a probability that the event impacted the values of the measure aggregated over the prediction period and over the set of dimension members.

9. A method according to claim 6, wherein determining the event comprises determining a selected time period and determining the event and a second event based on the time period, the method further comprising:
determining second control dimension members associated with the second event;
determining third values of the measure aggregated over the control period and second control dimension members, and not aggregated over at least one of the set of dimension members;
determining a second model associating the first values and the third values; and
determining second predicted values of the measure over the prediction period based on the second model and on values of the measure aggregated over the prediction period and over the second control dimension members, and not aggregated over at least one of the set of dimension members,
wherein the visualization is based on the predicted values of the measure, the second predicted values of the measure, and values of the measure aggregated over the prediction period and over the set of dimension members.

10. A method according to claim 6, wherein determining the model comprises training a Bayesian network.

11. A non-transitory computer-readable medium storing processor-executable process step which, when executed by a processor of a computing system, cause the computing system to:
determine a measure, a set of dimension members and an event associated with a data source;
determine control dimension members associated with the event;
determine first values of the measure aggregated over a control period and over the set of dimension members;
determine second values of the measure aggregated over the control period and control dimension members, and not aggregated over at least one of the set of dimension members;
determine a model associating the first values and the second values;
determine predicted values of the measure over a prediction period occurring after the control period, based on the model and on values of the measure aggregated over the prediction period and over the control dimension members, and not aggregated over at least one of the set of dimension members; and
generate a visualization based on the predicted values of the measure and values of the measure aggregated over the prediction period and over the set of dimension members.

12. A medium according to claim 11, wherein the visualization depicts the predicted values of the measure and values of the measure aggregated over the prediction period and over the set of dimension members.

13. A medium according to claim 12, wherein the visualization indicates a probability that the event impacted the values of the measure aggregated over the prediction period and over the set of dimension members.

14. A medium according to claim 11, wherein determination of the event comprises determining a selected time period and determining the event and a second event based on the time period, the processor-executable process step, when executed by a processor of a computing system, further cause the computing system to:
determine second control dimension members associated with the second event;
determine third values of the measure aggregated over the control period and second control dimension members, and not aggregated over at least one of the set of dimension members;
determine a second model associating the first values and the third values; and
determine second predicted values of the measure over the prediction period based on the second model and on values of the measure aggregated over the prediction period and over the second control dimension members, and not aggregated over at least one of the set of dimension members,
wherein the visualization is based on the predicted values of the measure, the second predicted values of the measure, and values of the measure aggregated over the prediction period and over the set of dimension members.

15. A medium according to claim 11, wherein determination of the model comprises training of a Bayesian network.
